(19) United States
(12) Patent Application Publication
(10) Pub. No.: US 2023/0008472 A1
(43) Pub. Date: Jan. 12, 2023

(54) PRINTING REFILL WITH RESERVE TANKS

(71) Applicant: HEWLETT-PACKARD DEVELOPMENT COMPANY, L.P., Spring, TX (US)

(72) Inventors: Paul Allan Osborne, Vancouver, WA (US); Christopher John Arnold, Vancouver, WA (US); Theodore W. Lamb, Vancouver, WA (US)

(73) Assignee: HEWLETT-PACKARD DEVELOPMENT COMPANY, L.P., Spring, TX (US)

(21) Appl. No.: 17/782,860

(22) PCT Filed: Dec. 9, 2019
(86) PCT No.: PCT/US2019/065178

§ 371 Date: Jun. 6, 2022

(51) Int. Cl. B41J 2/175

(52) U.S. Cl. CPC B41J 2/17506; B41J 2/17596

(57) ABSTRACT

In one example in accordance with the present disclosure, a print fluid refill system is described. The print fluid refill system includes a reservoir to hold a volume of print fluid to be supplied to a printhead. The print fluid refill system also includes a pump to 1 ) draw print fluid from the reservoir via a reservoir line and 2) transport print fluid to a reserve tank via a reserve line. The print fluid refill system also includes the reserve tank to, during refill of the reservoir, supply print fluid to a printhead via a printhead line. The reserve tank supplies print fluid to the printhead when fluid is passed to the reservoir via a return line.

### BACKGROUND

Printing systems refer to a combination of hardware components that form markings such as text, images, or other patterns on a target surface. Different printing systems dispense different types of print compound on the target surface. For example, a two-dimensional (2D) printer provides wet print compound such as ink, or dry compound such as toner, to form images/text on print media. In another example, a three-dimensional (3D) printer provides fluid, such as a fusing agent, or a dry material such as particulate build material into a bed. Over time, the print compound that is deposited on the target is depleted.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a print fluid refill system with a reserve tank, according to an example of the principles described herein.

FIG. 2 is a diagram of a printing system with a reserve tank during printing, according to an example of the principles described herein.

FIG. 3 is a diagram of a printing system with a reserve tank during refilling when a refill container contains print fluid, according to an example of the principles described herein.

FIG. 4 is a diagram of a printing system with a reserve tank during refilling when a refill container is empty, according to an example of the principles described herein.

FIG. 5 is a flow diagram of a method of refilling a print fluid reservoir using a reserve tank, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Printing systems in general dispense print compound onto a surface in the form of images, text, or other patterns. Different printing systems dispense different print compounds. For example, the print compound may be dry, or particle-based such as toner. In other examples, the print compound may be a liquid, such as liquid ink. Other types of compound may also be deposited on the surface via a printing system. For example, a three-dimensional printer may deposit a powder material that is to be sintered, fused, or otherwise solidified. Such a three-dimensional printer may also deposit an agent, that is dry or wet, which facilitates the solidifying of the powder material into a three-dimensional object. Over time, the repositories from which the print compound are drawn, are depleted. Accordingly, a refill container may be used to refill the reservoir. Specifically, the printing system may include a port to receive the refill container. The refill container is inserted into the port and print fluid is directed through tubes to the reservoir so that the printing system can continue to process print jobs.

While there is great value in offering a refillable reservoir and while refill containers provide an effective way to provide a printing system with additional print compound, advancements in print refilling may increase the rate and efficacy with which printing is performed. For example, it may be the case that printing is stopped during refill. Obviously, such an interruption of the printing operations of the printing system effect the output rate. Additionally, in some cases, such a pause may affect the operation of upstream and/or downstream devices.

Accordingly, the present specification describes a system that allows printing during refill. However, allowing printing during a refill operation may similarly complicate printing. For example, during a refill operation, the refill container may become empty while a pump that draws the print fluid from the refill container is still running. In this example, rather than drawing print fluid, the pump draws air into the system. In some examples, this air makes its way to the printhead of the printing system. Air in the printing system may affect print quality and printhead life. For example, in some cases the print fluid is a coolant to nozzles of the printhead and a lack of print fluid, i.e., the presence of air, may cause the nozzles to overheat, thereby shortening their life span. Moreover, the lack of a continuous supply of print fluid to the printhead may cause the print fluid in the printhead to dry, crust, and potentially block nozzles, heaters, or other components in the printhead.

Accordingly, the present specification allows for printing during a refill operation by inserting a reserve tank that, during refill, continues to supply print fluid to the printhead and that has enough capacity to prevent air from being drawn into the printhead. With such a system, a printing system may continue to print during a refill operation with the assurance that air ingestion into the printhead will not occur. That is, the reserve tank enables printing during a refill cycle and allows the print fluid refill system to drain the refill container without risking air ingestion into the printhead when the refill container is empty.

Specifically, the present specification describes a print fluid refill system. The print fluid refill system includes a reservoir to hold a volume of print fluid to be supplied to a printhead. The system also includes a pump. The pump draws print fluid from the reservoir via a reservoir line and transports print fluid to a reserve tank via a reserve line. The system also includes a reserve tank to, during refill of the reservoir, supply print fluid to a printhead via a printhead line. In this example, the reserve tank supplies print fluid to the printhead when fluid, such as air or print fluid, is passed to the reservoir via a return line.

The present specification also describes a method. According to the method, during a refill operation, print fluid is passed from the refill container to a reservoir through a reserve tank and print fluid is passed from the reserve tank to the printhead. During the same refill operation when the refill container is empty, air is prevented from re-entering the printhead by maintaining a print fluid volume at a printhead line port.

In another example, the printing system includes a reservoir to hold a volume of print fluid to be supplied to a printhead and a reserve tank. The reserve tank includes a printhead line port disposed along a bottom surface of the reserve tank and a return line port disposed above the printhead port. The reserve tank also includes a reserve line port. The printing system includes a pump to circulate print fluid through the reserve tank during printing and refilling, and a refill port to receive a refill container.

Such systems and methods 1) enable printing during a print fluid refill operation: 2) prevent potentially damaging air ingestion into the printhead; and 3) ensure complete usage of the print fluid in the refill container as a user does not have to prematurely remove the refill container to prevent air ingestion.

As used in the present specification and in the appended claims, the term “fluid” refers to any variety of fluid including air and print fluid. Accordingly, as used in the present specification and in the appended claims, the term “print fluid” refers to a liquid print compound that is deposited on a surface. Examples of such print fluids include liquid inks, pigments, and agents used in additive manufacturing.

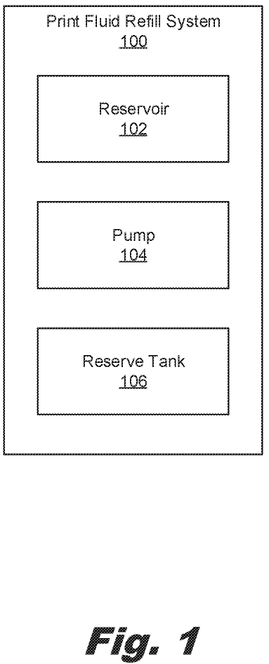

Turning now to the figures, FIG. 1 is a block diagram of a print fluid refill system (100) with a reserve tank (106), according to an example of the principles described herein. As described above, during use, the print fluid within a printing system may become depleted such that it should be refilled to continue printing operations. The print fluid refill system (100) provides the reservoir (102) with additional print fluid such that printing may continue.

The print fluid refill system (100) includes a reservoir (102) to hold a volume of print fluid that is to be supplied to a printhead. That is, a printhead includes components that eject print fluid onto a target surface, whether that surface be a two-dimensional surface such as paper, a powder bed for additive manufacturing, or any other type of target surface. The reservoir (102) maintains a volume of the print fluid that is available to the printhead for such deposition.

The print fluid that is supplied may be of a variety of types. For example, it may be a fusing agent or colored ink. In some examples, multiple print fluid refill systems (100) may be implemented in a printing system. For example, a color printer may have different print fluid refill systems (100) disposed therein, each supplying a respective printhead with a different colored ink.

The print fluid refill system (100) also includes a pump (104). During printing, capillary action and pressure differentials may draw print fluid towards the printhead. That is, a printhead to which the print fluid refill system (100) is coupled may include internal regulators that will stay closed until the printhead calls for more print fluid. When the printhead calls for more fluid, these regulators open, drawing print fluid towards the ejection mechanisms.

The pump (104) works in conjunction with this capillary action and pressure differentials to drive print fluid through the printing system and the reservoir (102). Specifically, the pump (104) draws fluid from the reservoir (102) via a reservoir line. That is, as described above, the reservoir (102) holds a volume of print fluid available to the printhead for printing. This pump (104) draws that print fluid out of that reservoir (102) and transports this print fluid to a reserve tank (106) via a reserve line. The print fluid is directly accessible to the printhead via the reserve tank (106). Put another way, the reserve tank (106) is disposed between the reservoir (102) and printhead and provides a holding tank which is directly coupled to the printhead via printhead lines.

The print fluid refill system (100) also includes a reserve tank (106) that as described above, is an intermediate repository of print fluid, which is directly coupled to the printhead. The reserve tank (106) also facilitates reservoir (102) refill. That is, there is a supply line that couples the reserve tank (106) to the reservoir (102) and that is downstream of the pump (104). Accordingly, the pump (104) draws print fluid from a refill container into the reserve tank (106). This print fluid is then pushed from the reserve tank (106) through this supply line to the reservoir (102).

All during this refill cycle, the reserve tank (106) supplies print fluid to the printhead via a printhead line. That is, printing through a printhead and refilling a reservoir (102) can happen simultaneously.

The print fluid is continually passed to the printhead, even when air is passed to the reservoir (102) via a return line. For example, when refilling fluid to a reservoir (102), the print fluid passes from the refill container to the reserve tank (106). The print fluid then passes from the reserve tank (106) to the reservoir (102). However, as the refill container becomes empty, air is drawn by the pump (104) into the reserve tank (106). Were this air allowed to pass into the printhead line, printhead life and print quality may be negatively impacted. For example, air bubbles in the printhead may reduce or prevent the ejection of a drop of print fluid from nozzles of the printhead thus affecting print quality. As described above, air bubbles can also damage printhead components thus reducing their operational life. To address this, the reserve tank (106) is structured so that this air, rather than passing to the printhead, is passed to the reservoir (102) so that it can be properly vented. In other words, the reserve tank (106) has some volume of print fluid from which the printhead can continue to draw, even when the pump (104) is pulling in air from an empty refill container. This air, rather than remaining in the reserve tank (106), is evacuated to the reservoir (102), which forms an air-path loop so that the air does not build up in the reservoir (102).

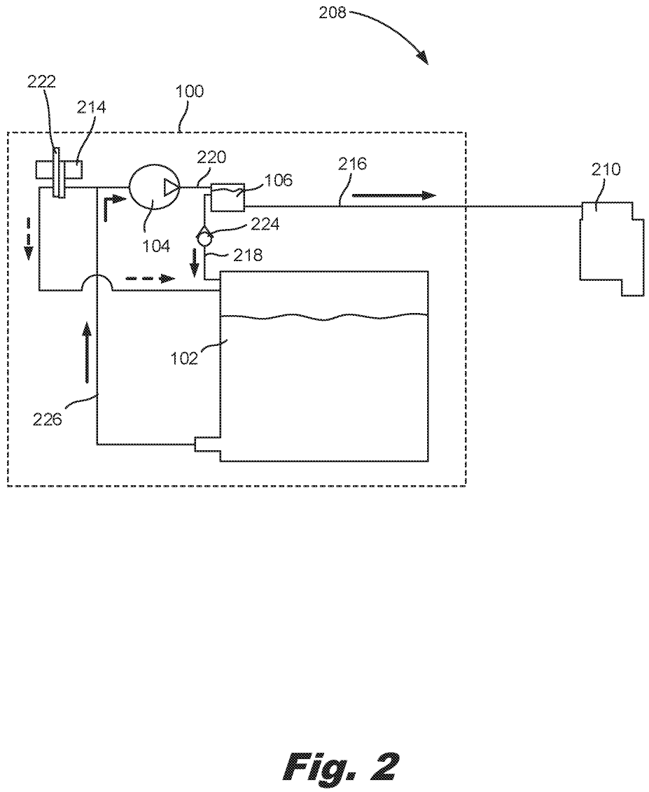

FIG. 2 is a diagram of a printing system (208) with a reserve tank (106) during printing, according to an example of the principles described herein. The printing system (208) includes the print fluid refill system (100) which includes a reservoir (102) to hold a volume of print fluid to be supplied to a printhead (210). The printing system (208) also includes the printhead (210) that ejects print fluid supplied from the reserve tank (106).

The printhead (210) may include any number of components to effectuate fluid ejection. For example, the printhead (210) may include a number of nozzles. A nozzle may include an ejector, a firing chamber, and an opening. The opening may allow fluid, such as ink, to be deposited onto a surface, such as a print medium. The firing chamber may include a small amount of fluid. The ejector may be a mechanism for ejecting fluid through the opening from the firing chamber, where the ejector may include a firing resistor or other thermal device, a piezoelectric element, or other mechanism for ejecting fluid from the firing chamber.

For example, the ejector may be a firing resistor. The firing resistor heats up in response to an applied voltage. As the firing resistor heats up, a portion of the fluid in the firing chamber vaporizes to form a bubble. This bubble pushes liquid fluid out the opening and onto the print medium. As the vaporized fluid bubble pops, fluid is drawn into the firing chamber and the process repeats. In this example, the printhead (210) may be a thermal inkjet (TIJ) printhead (210).

In another example, the ejector may be a piezoelectric device. As a voltage is applied, the piezoelectric device changes shape which generates a pressure pulse in the firing chamber that pushes a fluid out the opening and onto the print medium. In this example, the printhead (210) may be a piezoelectric inkjet (PIJ) printhead (210).

FIG. 2 also depicts the pump (104) which circulates fluid through the reserve tank (106) during printing and refilling. As depicted in FIG. 2, the pump (104) may be upstream of the reserve tank (106), reservoir (102), and the printhead (210) and downstream of the refill port (214).

As described above, the reserve tank (106) provides print fluid to the printhead (210) during a refill operation, whether or not the refill container is empty. Specifically, the reserve tank (106) includes a printhead line (216) port that is disposed along a bottom surface of the reserve tank (106) and fluidly connects the reserve tank (106) to the printhead (210).

The reserve tank (106) also includes a return line (218) port that is disposed above the printhead line (216) port. The return line (218) port fluidly connects the reserve tank (106) to the reservoir (102). A space between the printhead line (216) port and the return line (218) port defines an amount of print fluid available for printing during a refill operation when a refill container is empty. This distance may be sized to allow a predetermined amount of content to be printed during a refill operation when the refill container is empty. That is, it may be difficult to ascertain when a refill container is empty as the refill container may be opaque and the print fluid refill system (100) may not include a sensor. Accordingly, the space between these two ports provides a buffer wherein a user can ascertain that the refill container is empty, based on for example passage of an amount of time estimated to relate to the time to empty the refill container, and can close the refill port (214) such that air is not ingested into the reserve tank (106).

The reserve tank (106) also includes a reserve line (220) port that fluidly connects the reserve tank (106) to the refill container. In some examples, the reserve line (220) port is disposed above the return line (218) port and above the printhead line (216) port.

As described above, FIG. 2 depicts a printing system (208) during printing. An example of the operation of the different components during printing is now presented. In FIG. 2, print fluid flow is indicated by solid arrows whereas air flow is indicated by dashed arrows.

In this example, the pump (104) draws print fluid from the reservoir (102) into the reserve tank (106). Via capillary action, print fluid is drawn through the printhead line (216) port towards the printhead (210) to be used in printing. During printing, the reserve line (218) port acts as an overflow to return excess print fluid in the reserve tank (106) to the reservoir (102).

Note that if the print fluid level in the reserve tank (106) drops below the return line (218) port, the reserve tank (106) vents air to the reservoir (102). That is, the reserve tank (106) relies on gravity to make sure print fluid covers the printhead line (216) port to the printhead (210). Accordingly, any air input to the reserve tank (106) will end up being returned to the reservoir (102). Put another way, the reserve tank (106) separates air from print fluid. Without the reserve tank (106), air may get sucked into the printhead (210), which may shorten printhead (210) life and result in print quality defects.

During printing, a refill port (214) which receives a refill container is closed, preventing any flow through it. In some examples, the refill port (214) includes a vent (222). As the printhead (210) operation causes the level of the print fluid in the reservoir (102) to drop, this vent (222) allows air to flow in to the reservoir (102) to maintain near atmospheric pressure in the reservoir (102).

In some examples, the print fluid refill system (100) portion of the printing system (208) includes a pressure control device (224) to regulate pressure in the print fluid refill system (100). This pressure control device (224) may be disposed along the return line (220) between the reserve tank (106) and the reservoir (102). In some examples, the pressure control device (224) may be a ball on a seat with a spring behind it. As fluid pushes harder against the ball, the spring compresses and fluid can pass into the reservoir (212). Such a pressure control device (224) ensures a constant pressure in the reserve tank (106) and thereby a constant pressure differential which transports the print fluid along the printhead lines (216). That is, the pressure control device (224) keeps the print fluid at a particular pressure, which particular pressure drives fluid through the printhead lines (216) at a flowrate selected for the printhead (210). In some examples, the reservoir (102) and/or the reserve tank (106) include baffles or other flow directors to help prevent frothing, mixing, or other undesirable behavior.

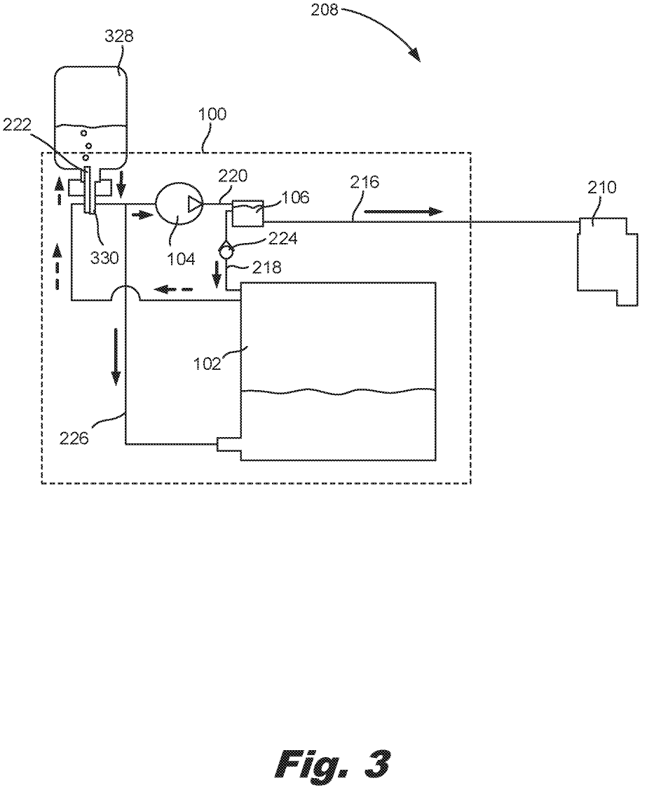

FIG. 3 is a diagram of a printing system (208) with a reserve tank (106) during refilling when a refill container (328) contains print fluid, according to an example of the principles described herein. As described above, to refill the reservoir (102), a refill container (328) is inserted into the refill port (FIG. 2, 214) such that print fluid can flow out of the fluid tube (330).

In this example, during the refill, the refill container (328) is fluidly coupled to the reservoir line (226). The reservoir line (226) is the line that couples the reservoir (102) and the pump (104). During a refill operation, print fluid passes from the refill container (328) to the reservoir (102), through a portion of the reservoir line (226), through the reserve line (220), into the reserve tank (106) and through the return line (218) past a pressure control device (224).

Specifically, during reservoir (102) fill, the fill port (FIG. 2, 214) is uncapped and the refill container (328) is attached thereto. The pump (104) remains active during refill and pulls fluid from the refill container (328) through the supply tube (330) into the reserve tank (106). Note that in this example, some fluid does travel through the reservoir line (226) towards the reservoir (102) directly.

The fluid in the reserve tank (106) flows through two outputs. First, fluid near the bottom passes through the printhead line (216) port to the printhead (210). When the fluid gets to a certain height, it returns to the reservoir (102) through the return line (220). That is, during refilling, the reserve tank (106) provides printing fluid to the printhead (210) and refills the reservoir (102), all while preventing air from entering the printhead (210). The prevention of air ingestion into the printhead (210) is based on the height difference between the printhead line (216) port and the return line (218) port. That is, any print fluid makes its way to the bottom of the reserve tank (106) and is ejected through the printhead line (216) port while air above the print fluid is passed to the reservoir (102) through the return line (218).

As the reservoir (102) fills with print fluid, it pushes air back into the refill bottle via the vent (222). This air allows print fluid to more readily flow out of the refill container (328) through the supply tube (330). If the reservoir (102) becomes full during a refill operation while the refill container (328) still has fluid therein, the pump (104) may continue to operate, wherein print fluid is circulated from the refill container (328) to the reserve tank (106) to the reservoir (102) and then back to the refill container (328) through the vent (222).

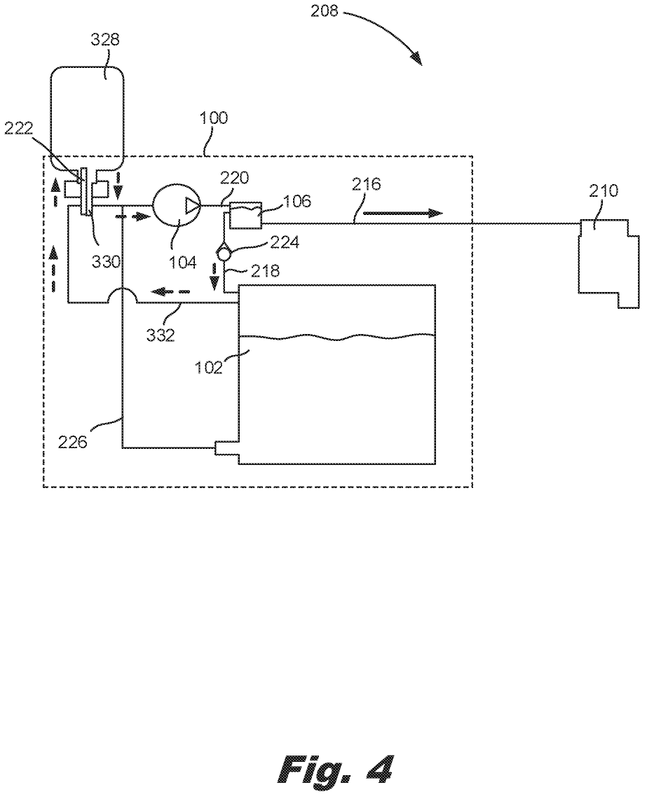

FIG. 4 is a diagram of a printing system (208) with a reserve tank (106) during refilling when a refill container (328) is empty, according to an example of the principles described herein. That is, at the point depicted in FIG. 4, all print fluid may have been drained from the refill container (328) before the reservoir (102) is filled. As there may not be a way to detect when a refill container (328) is empty, the pump (104) may continue to operate. However, as there is no print fluid in the refill container (328) air, rather than print fluid, is pumped into the reserve tank (106). As described above, if air is allowed into the printhead line (216), damage to printhead (210) components and/or reduced print quality may result.

A described above, the form of the reserve tank (106) prevents this. For example, even while air is being pumped into the reserve tank (106), print fluid may still reside in the bottom of the reserve tank (106). This print fluid is drawn into the printhead (210). The air, by comparison, being above the print fluid is not in contact with the printhead line (218) unless the reserve tank (106) is completely empty. Rather, the air is passed through the return line (218) into the reservoir (102) where it can be cycled back to the refill container (328). In other words, the reserve tank (106) allows for printing to continue up to the volume of fluid in the reserve tank (106) between the printhead line (216) port and the return line (218) port. In summary, when the refill container (328) is empty, the air has the following flow path: through the reservoir line (226), pump (104), and reserve line (220) to the reserve tank (106). From there the air passes through the return line (218) and into the reservoir (102). From here, the air is recycled through a vent line (332) that goes through the vent (222) into the refill container (328).

The air travels continuously along this path, not interrupting printing, until the refill container (328) is removed. Upon removal, the pump (104) continues to operate and draws fluid from the reservoir (102) as depicted in FIG. 2 and printing continues. Thus, the present print fluid refill system (100) allows for printing throughout the entire refill cycle.

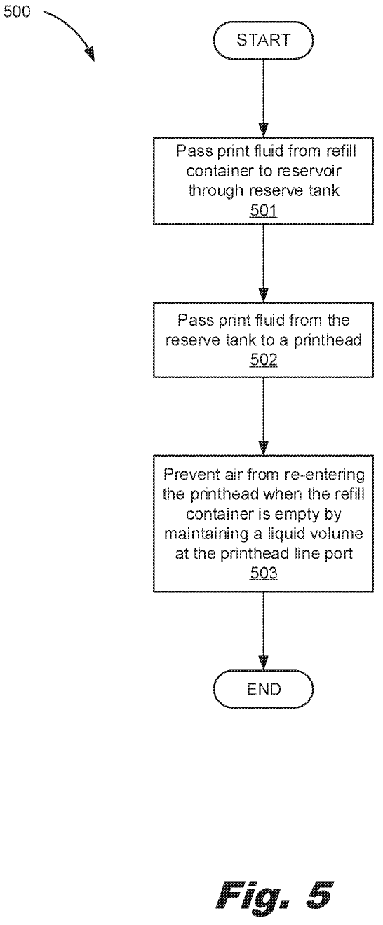

FIG. 5 is a flow diagram of a method (500) of refilling a print fluid reservoir (FIG. 1, 102) using a reserve tank (FIG. 1, 106), according to an example of the principles described herein. The method (500) describes operations that occur during two different stages of refill, one when the refill container (FIG. 3, 328) is full and a second when the refill container (FIG. 3, 328) is empty, that is when the refill container (FIG. 3, 328) has deposited all of its contents into the print fluid refill system (FIG. 1, 100).

During refill when the refill container (FIG. 3, 324) contains print fluid, print fluid is passed (block 501) from the refill container (FIG. 3, 328) to the reservoir (FIG. 1, 102) through the reserve tank (FIG. 1, 106). That is, fluid travels along a path through the pump (FIG. 1, 104), and into the reserve tank (FIG. 1, 106). From here the fluid is either passed (block 502) through a printhead line (FIG. 2, 216) port towards the printhead (FIG. 2, 210) for use in printing or passes (block 501) through a return line (FIG. 2, 218) to the reservoir (FIG. 1, 102). In other words, according to the method (500), the reservoir (FIG. 1, 102) may be refilled without interrupting the printing operations of the printhead (FIG. 2, 210). Doing so increases printing efficiency as printing is not stopped to perform a refill.

During refill, it may be the case that the contents of the refill container (FIG. 3, 328) are less than the available volume in the reservoir (FIG. 1, 102). In this example, the refill container (FIG. 3, 328) may empty before the reservoir (FIG. 1, 102) is full. It may be the case that there is no way to immediately determine when the refill container (FIG. 3, 328) is empty and therefore the pump (FIG. 1, 104) may continue to operate. In so doing, rather than drawing print fluid from the refill container (FIG. 3, 328), the pump (FIG. 1, 104) draws air from the refill container (FIG. 3, 328) into the reserve tank (FIG. 1, 106). If this air were allowed to pass to the printhead (FIG. 2, 210), damage and reduced print quality may result. To alleviate this, the reserve tank (FIG. 1, 106) is particularly structured to hold a volume of print fluid notwithstanding the entry of air into the reserve tank (FIG. 1, 106). Specifically, the printhead line (FIG. 2, 216) port is disposed at the bottom of the reserve tank (FIG. 1, 106) where the fluid falls while any air that enters is on top of the print fluid above the printhead line (FIG. 2, 216) port. In other words, when the refill container (FIG. 3, 328) is empty, fluid is still drawn from the reserve tank (FIG. 1, 106) to the printhead (FIG. 2, 210).

Not only is the print fluid separate from air, but it is actively removed from the reserve tank (FIG. 1, 106). That is, the return line (FIG. 2, 218) couples the reserve tank (FIG. 1, 106) to the reservoir (FIG. 1, 102). Air that is drawn from the refill container (FIG. 3, 328) is drawn through this return line (FIG. 2, 218) into the reservoir (FIG. 1, 102). That is, when the refill container (FIG. 3, 328) is empty, air is prevented (block 503) from entering the printhead (FIG. 2, 210) by maintaining a liquid volume at a printhead line (FIG. 2, 216) port and venting the air in the reserve tank (FIG. 1, 106) to the reservoir (FIG. 1, 102).

Accumulating air in the reservoir (FIG. 1, 102) can then be circulated back to the refill container (FIG. 3, 328) forming an air loop. Accordingly, the pumping of air may continue for any amount of time until a user terminates the refill operation by removing the refill container (FIG. 3, 328). Once removed, the pump continues to operate, but in this case draws print fluid from the reservoir (FIG. 1, 102) into the reserve tank (FIG. 1, 106) to be used for printing.

Such systems and methods 1) enable printing during a print fluid refill operation; 2) prevent poteritially damaging air ingestion into the printhead; and 3) ensure complete usage of the print fluid in the refill container as a user does not have to prematurely remove the refill container to prevent air ingestion.

What is claimed is:

1. A print fluid refill system, comprising:
a reservoir to hold a volume of print fluid to be supplied to a printhead;
a pump to:
draw print fluid from the reservoir via a reservoir line; and
transport print fluid to a reserve tank via a reserve line;
the reserve tank to, during refill of the reservoir, supply print fluid to the printhead via a printhead line, wherein the reserve tank supplies print fluid to the printhead while fluid is passed to the reservoir via a return line.

2. The print fluid refill system of claim 1, further comprising a refill port to receive a refill container.

3. The print fluid refill system of claim 2, wherein during refill:
the refill container is fluidly coupled to the reservoir line; and
print fluid passes from the refill container to the reservoir through the reservoir line, reserve line, reserve tank, and return line.

4. The print fluid refill system of claim 1, further comprising a pressure control device to regulate pressure in the print fluid refill system, wherein the pressure control device is disposed along the return line between the reserve tank and the reservoir.

5. The print fluid refill system of claim 1, wherein a return line port in the reserve tank is disposed above a printhead line port in the reserve tank.

6. The print fluid refill system of claim 1, wherein a reserve line port in the reserve tank is disposed above the return line port and above the printhead line port.

7. A method, comprising:
during a refill operation:
passing print fluid from the refill container to a reservoir through a reserve tank;
passing print fluid from the reserve tank to the printhead; and
when the refill container is empty, preventing air from re-entering the printhead by maintaining a print fluid volume at a printhead line port.

8. The method of claim 7, further comprising, during printing when the refill container is not coupled to the reserve tank, drawing print fluid from the reservoir into the reserve tank.

9. A printing system, comprising:
a reservoir to hold a volume of print fluid to be supplied to a printhead;
a reserve tank comprising:
a printhead line port disposed along a bottom surface of the reserve tank;
a refill port to receive a refill container;
a return line port disposed above the printhead port; and
a reserve line port; and
a pump to circulate print fluid through the reserve tank during printing and refilling.

10. The printing system of claim 9, wherein a space between the printhead line port and the return line port defines an amount of print fluid available for printing during a refill operation when the refill container is empty.

11. The printing system of claim 10, wherein the space between the printhead line port and the return line port is sized to allow a predetermined amount of content to be printed during the refill operation when the refill container is empty.

12. The printing system of claim 9, wherein the pump is upstream of the reserve tank, the reservoir, and the printhead.

13. The printing system of claim 12, wherein the pump is downstream of the refill port.

14. The printing system of claim 10, wherein the reserve tank, during printing:
provides print fluid to the printhead; and
vents air to the reservoir; and.

15. The printing system of claim 10, wherein the reserve tank, during refilling:
provides print fluid to the printhead;
refills the reservoir; and
prevents air from entering the printhead.
